(19) United States
(12) Patent Application Publication
(10) Pub. No.: US 2013/0162531 A1
(43) Pub. Date: Jun. 27, 2013

(54) METHOD OF RECOGNIZING USER OPERATION AND CAPACITIVE POINTING DEVICE THEREOF

(71) Applicant: HOWAY CORP., KAOHSIUNG CITY (TW)

(72) Inventors: JAOCHING LIN, TAIPEI CITY (TW); LINABEL CHU, TAIPEI CITY (TW); GARY LEE, NEW TAIPEI CITY (TW)

(73) Assignee: HOWAY CORP., KAOHSIUNG CITY (TW)

(21) Appl. No.: 13/693,327

(22) Filed: Dec. 4, 2012

(30) Foreign Application Priority Data
Dec. 6, 2011 (TW) 100144848

(51) Int. Cl. G09G 5/08

(52) U.S. Cl. CPC G09G 5/08
USPC 345/157

(57) ABSTRACT

A method of recognizing user operation uses a capacitive pointing device. An original capacitance in the capacitive pointing device occurs when the capacitive pointing device is touched. The method includes the following steps of configuring the capacitive pointing device to detect a capacitance in the capacitive pointing device, and when the capacitance corresponds to the original capacitance, to implement an operation recognizing module to recognize the user operation by a duration of occurrence of the original capacitance, and to generate an operation command signal corresponding to the user operation determined thereby.

### CROSS-REFERENCE TO RELATED APPLICATION

This application claims priority of Taiwanese Patent Application No. 100144848, filed on Dec. 6, 2011.

### BACKGROUND OF THE INVENTION

1. Field of the Invention

The present invention relates a method of recognizing user operation, more particularly to a method of recognizing user operation using a capacitive pointing device.

2. Description of the Related Art

In a conventional capacitive pointing device which is in the form of a joystick, a metal plate is spaced apart from a plurality of metal electrodes and is configured to result in a capacitance effect with the metal electrodes, and a distance between the metal plate and each of the metal electrodes may be controlled through an angle at which the joystick is inclined. Variation in the distance between the metal plate and each of the metal electrodes results in variation in a capacitance therebetween, such that a direction in which the joystick is inclined may be determined according to the variation in the capacitance between the metal plate and each of the metal electrodes. However, the conventional capacitive pointing device is merely capable of controlling movement of a movable pointer (e.g., a cursor), and cannot be used to perform a click operation since it lacks a button.

### SUMMARY OF THE INVENTION

Therefore, an object of the present invention is to provide a method of recognizing user operation, and a capacitive pointing device for implementing the method. The capacitive pointing device is capable of controlling movement of a movable pointer (e.g., a cursor), and has a touch control function for recognizing click operation by means of recognizing user operation performed on the capacitive pointing device.

In a first aspect of the present invention, the method of recognizing user operation using a capacitive pointing device is provided. The capacitive pointing device includes a plurality of electrical conductors and an operating unit that is spaced apart from the electrical conductors and that is configured to result in a capacitance effect with the electrical conductors. An original capacitance between the operating unit and each of the electrical conductors occurs when the operating unit such as a finger of a user is touched. The method comprises the following steps of:
a) configuring the capacitive pointing device to detect a capacitance between the operating unit and each of the electrical conductors; and
b) when the capacitance detected in step a) corresponds to the original capacitance, configuring the capacitive pointing device to implement an operation recognizing module to recognize the user operation by a duration of occurrence of the original capacitance, and to generate an operation command signal corresponding to the user operation determined thereby.

In a second aspect of the present invention, the capacitive pointing device comprises at least two electrical conductors, an operating unit, and a controller. The electrical conductors are arranged in an annular shape and are spaced apart from each other. The operating unit is spaced apart from the electrical conductors, is configured to result in a capacitance effect with the electrical conductors, and includes a touch portion resulting in an original capacitance between the operating unit and each of the electrical conductors when being touched. The controller is electrically coupled to the electrical conductors and the operating unit, and has an operation recognizing module. The controller is configured to detect a capacitance between the operating unit and each of the electrical conductors, to implement the operation recognizing module to recognize a user operation by a duration of occurrence of the original capacitance when the capacitance detected by the controller corresponds to the original capacitance, and to generate an operation command signal corresponding to the user operation determined thereby

Preferably, the controller is configured to determine the occurrence of the original capacitance between the operating unit and each of the electrical conductors when the duration of the occurrence of the original capacitance is longer than a threshold time.

Preferably, the operating unit is user-operable to move horizontally with respect to the electrical conductors so as to result in variation of the capacitance between the operating unit and each of the electrical conductors. The controller further has a direction recognizing module and is configured to determine whether an amount of the variation of the capacitance between the operating unit and any one of the electrical conductors is greater than a predetermined threshold, and to implement the direction recognizing module to generate, according to the variation of the capacitance, a movement signal which represents a movement of the operating unit with respect to the electrical conductors when the determination thus made is affirmative.

Preferably, with the direction recognizing module, the controller is configured to determine a moving direction and an amount of the movement of the operating unit with respect to the electrical conductors according to the variation of the capacitance between the operating unit and each of the electrical conductors, and to generate the movement signal according to the moving direction and the amount of the movement of the operating unit.

The present invention is responsive to the user operation and may generate, according to the variation of the capacitance between the operating unit and each of the electrical conductors in the capacitive pointing device, the movement signal for controlling movement of a movable pointer. In addition, the present invention may achieve an effect of touch control, similar to a single tap, a double tap, or a tap-and-drag operation performed via a mouse button, by means of determining the user operation according to the duration of the occurrence of the original capacitance. In this way, by virtue of the capacitive pointing device of the present invention, a user may perform operation which is conventionally performed via a computer mouse.

### BRIEF DESCRIPTION OF THE DRAWINGS

Other features and advantages of the present invention will become apparent in the following detailed description of the embodiment with reference to the accompanying drawings, of which:

FIG. 1 is an exploded perspective view of a preferred embodiment of a capacitive pointing device according to the present invention;

FIG. 2 is a cross-sectional schematic side view of the preferred embodiment;

FIG. 3 is a schematic diagram illustrating arrangements of a conductor portion and a plurality of electrical conductors;

FIG. 4 is a schematic diagram illustrating that the conductor portion is moved to the right with respect to the electrical conductors;

FIG. 5 is a flow chart illustrating a preferred embodiment of a method of recognizing user operation according to the present invention;

FIG. 6 is a flow chart illustrating procedures of a first example of an operation recognizing module;

FIG. 7 is a timing diagram illustrating that the user operation is determined as a single tap in the first example of the operation recognizing module;

FIG. 8 is a timing diagram illustrating that the user operation is determined as a double tap in the first example of the operation recognizing module;

FIG. 9 is a timing diagram illustrating that the user operation is determined as a tap-and-drag operation in the first example of the operation recognizing module;

FIG. 10 is a flow chart illustrating procedures of a second example of the operation recognizing module;

FIG. 11 is a timing diagram illustrating that the user operation is determined as the single tap in the second example of the operation recognizing module;

FIG. 12 is a timing diagram illustrating that the user operation is determined as the double tap in the second example of the operation recognizing module;

FIG. 13 is a timing diagram illustrating that the user operation is determined as the tap-and-drag operation in the second example of the operation recognizing module;

FIG. 14 is a flow chart illustrating procedures of a third example of the operation recognizing module;

FIG. 15 is a timing diagram illustrating that the user operation is determined as the single tap in the third example of the operation recognizing module;

FIG. 16 is a timing diagram illustrating that the user operation is determined as the double tap in the third example of the operation recognizing module; and

FIG. 17 is a timing diagram illustrating that the user operation is determined as the tap-and-drag operation in the third example of the operation recognizing module.

### DETAILED DESCRIPTION OF THE EMBODIMENT

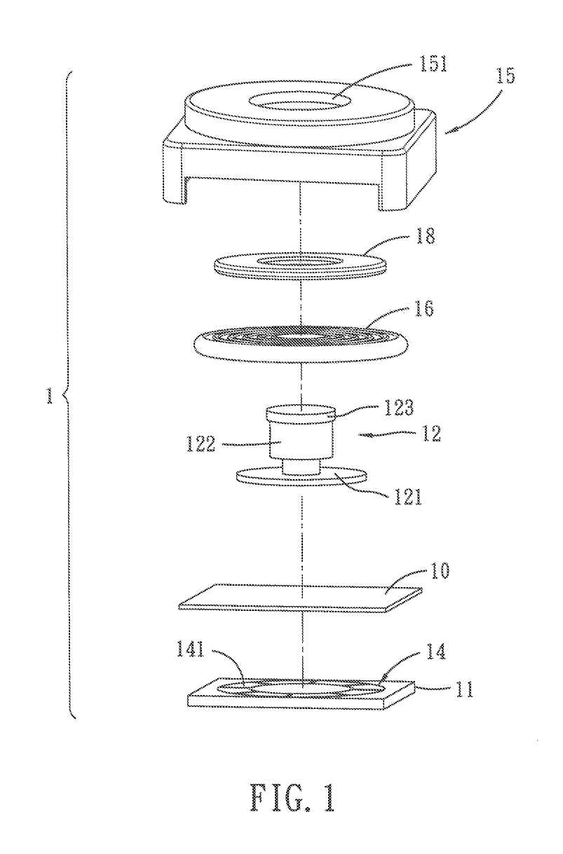

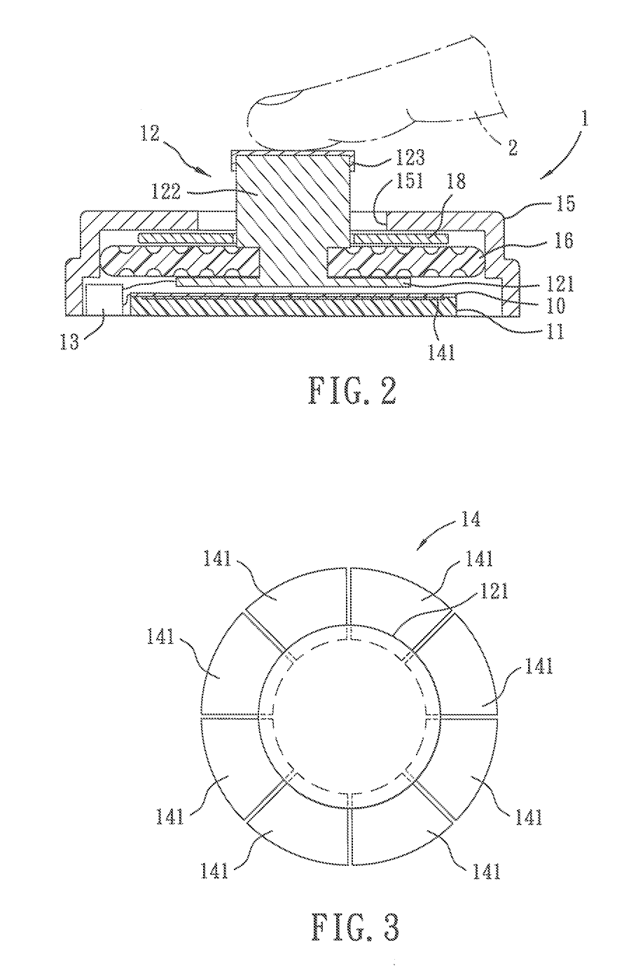

Referring to FIG. 1 and FIG. 2, a preferred embodiment of a capacitive pointing device 1 according to the present invention is illustrated. The capacitive pointing device 1 is configured to be applied to an electronic product, such as a notebook computer, a mobile phone, or a personal digital assistant (FDA). The capacitive pointing device 1 is operable, according to user operation, to control moving direction of a movable pointer (for example, a cursor or a pick marker on a menu) on a screen of the electronic product, and has a touch control function similar to operation of a mouse button, so as to open a menu displayed on the screen of the electronic product and to select a specific option on the menu.

In the preferred embodiment, the capacitive pointing device 1 comprises a circuit board 11, an operating unit 12, a controller 13 which is electrically coupled to the operating unit 12, a housing 15, a smooth plate 18, and an elastic component 16.

The circuit board 11 is disposed with a plurality of electrical conductors 141 which are electrically coupled to the controller 13. In this embodiment, the electrical conductors 141 are eight in number, are copper foils, are arranged in an annular shape and are angularly spaced apart from each other on a surface of the circuit board 11 so as to form an annular conductor unit 14 shown in FIG. 3. The annular conductor unit 14 has an outer diameter and an inner diameter.

The operating unit 12 is primarily made of a metal conductor, is spaced apart from the electrical conductors 141 of the circuit board 11, is configured to result in a capacitance effect with the electrical conductors 141, and is user-operable to move horizontally with respect to the electrical conductors 141. For a purpose of preventing the operating unit 12 from electrical contact with the electrical conductors 141, an insulating layer 10 (such as biaxially-oriented polyethylene terephthalate (BoPET), Mylar, etc.) may be provided between the operating unit 12 and the electrical conductors 141. Alternatively, a polytetrafluoroethylene (PTFE) coating may be applied on a surface of each of the electrical conductors 141 facing the operating unit 12.

Preferably, the operating unit 12 includes a conductor portion 121 which corresponds in position to the electrical conductors 141, an operating portion 122 which extends from the conductor portion 121 and away from the circuit board 11, and a touch portion 123 which covers a top end of the operating portion 122. The touch portion 123 may be made of an electrical-insulating material for resulting in an original capacitance between the operating unit 12 and each of the electrical conductors 141 when being touched. The conductor portion 121 is a circular conductor which has a diameter smaller than the outer diameter of the annular conductor unit 14 and greater than the inner diameter of the annular conductor unit 14. A user may touch the touch portion 123 with his/her finger, and may apply a force to the operating portion 122 via the touch portion 123 for moving the conductor portion 121 horizontally with respect to the electrical conductors 141.

In FIG. 1 and FIG. 2, the housing 15 defines a Receiving space, and the circuit board 11, the insulating layer 10 and the operating unit 12 are assembled in sequence from bottom to top and received in the receiving space of the housing 15. The housing 15 is formed with an opening 151, and the operating portion 122 of the operating unit 12 extends out of the housing 15 through the opening 151.

Further, in order to restore the operating unit 12, the elastic component 16 is disposed between the conductor portion 121 and the operating portion 122 of the operating unit 12. The elastic component 16 is in a shape of a circular board which has a diameter greater than the diameter of the conductor portion 121, and abuts against an inner surface of the housing 15. Specifically, the elastic component 16 includes two surfaces parallel to the conductive portion 121, and a plurality of concentric ring protrusions formed on the surfaces and being spaced apart from one another in radial directions. By virtue of the concentric ring protrusions, the elastic component 16 can be compressed uniformly and will not bulge out in a direction perpendicular to the radial direction. Moreover, an insulating coating, such as a PTFE coating, may be applied on a surface of the conductor portion 121 facing the elastic component 16 for protecting the conductor portion 121 and promoting a smooth slide of the conductor portion 121 with respect to the elastic component 16.

In addition, the smooth plate 18 of the preferred embodiment, for example, an annular iron sheet, surrounds the operating portion 122 and is disposed between the elastic component 16 and the housing 15. The smooth plate 18 has a relatively small friction coefficient, and is configured to press the elastic component 16 to secure the elastic component 16. By virtue of the smooth plate 18, a frictional force between the housing 15 and the elastic component 16 is reduced.

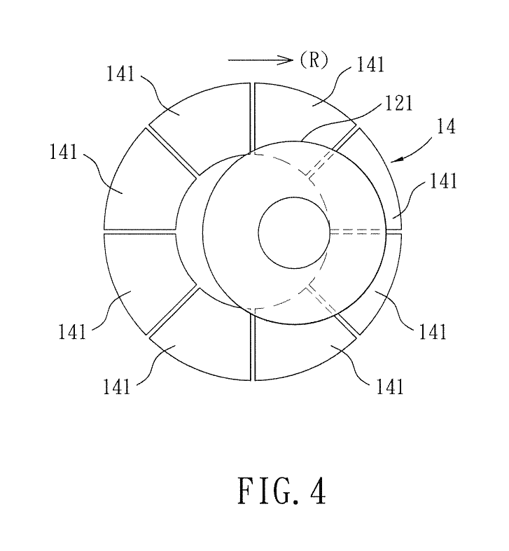

The controller 13 is configured to detect a capacitance between the operating unit 12 and each of the electrical conductors 141. Specifically, by means of providing an electric signal, such as a voltage signal, to the operating unit 12, the controller 13 may make the operating unit 12 result in the capacitance effect with the electrical conductors 141, so as to detect the capacitance between the operating unit 12 and each of the electrical conductors 141 in turns. In particular, a default capacitance between the operating unit 12 and each of the electrical conductors 141 occurs when the operating unit 12 is not touched, and the original capacitance between the operating unit 12 and each of the electrical conductors 141 occurs when the operating unit 12 is touched. The original capacitance is equal to a summation of a capacitance between a user's finger 2 and the operating portion 122 and a capacitance between the conductor portion 121 and each of the electrical conductors 141. The conductor portion 121 has a projected image that partially overlaps the annular conductor unit 14 formed by the electrical conductors 141 as best shown in FIG. 3. As shown in FIG. 4, when the touch portion 123 is touched by the user's finger 2 and the operating unit 12 is pushed to move horizontally with respect to the electrical conductors 141, an overlapping area between the projected image of the conductor portion 121 onto each of the electrical conductors 141 varies so as to result in variation of the capacitance between the operating unit 12 and each of the electrical conductors 141.

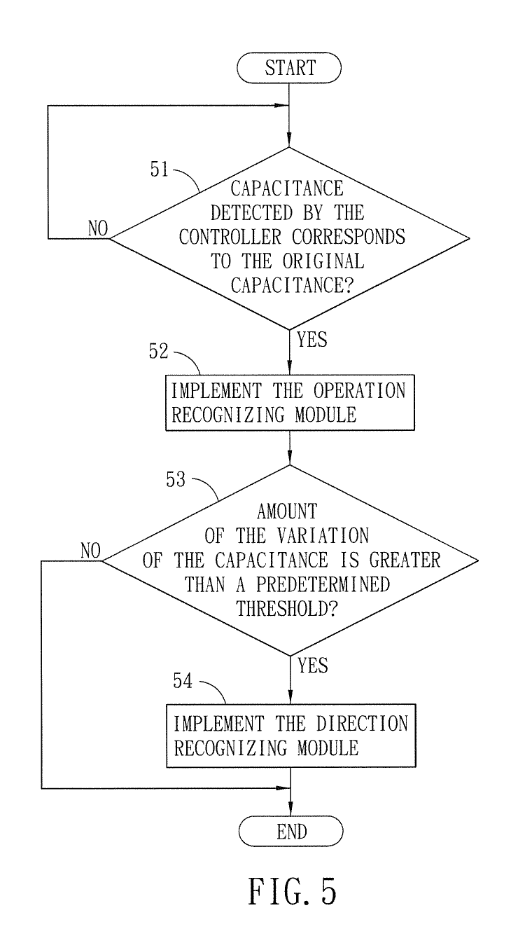

Moreover, the controller 13 has an operation recognizing module and a direction recognizing module. Referring to FIG. 5, in step 51 of a method of recognizing user operation using the capacitive pointing device 1, the controller 13 is configured to determine whether the capacitance detected thereby corresponds to the original capacitance. When the capacitance detected by the controller 13 does not correspond to the original capacitance, the controller 13 is configured to repeat step 51. When the capacitance detected by the controller 13 corresponds to the original capacitance, that is the touch portion 123 is being touched by the user's finger 2, the controller 13 is configured, in step 52, to implement the operation recognizing module to recognize the user operation by a duration of occurrence of the original capacitance, and to generate an operation command signal corresponding to the user operation determined thereby. More specifically, for preventing erroneous determination of occurrence of the original capacitance attributed to noise interference, the controller 13 is configured to determine the occurrence of the original capacitance between the operating unit 12 and each of the electrical conductors 141 when the duration of the occurrence of the original capacitance is longer than a threshold time (for example, 5 ms).

Subsequently, in step 53, the controller 13 is configured to determine whether an amount of the variation of the capacitance between the operating unit 12 and any one of the electrical conductors 141 is greater than a predetermined threshold. When the determination made in step 53 is affirmative, step 54 is performed. In step 54, the controller 13 is configured to implement the direction recognizing module to generate, according to the variation of the capacitance, a movement signal which represents a movement of the operating unit 12 with respect to the electrical conductors 141. Detailed descriptions of procedures to be performed in the operation recognizing module (i.e., step 52) and the direction recognizing module (i.e., step 54) are illustrated hereinafter.

In the direction recognizing module, referring to FIG. 4, the movement of the operating unit 12 toward a moving direction (R) increases the overlapping area between the projected image of the conductor portion 121 of the operating unit 12 and each of the electrical conductors 141 at the moving direction (R), and accordingly results in an increased amount of capacitance between the operating unit 12 and each of the electrical conductors 141 at the moving direction (R). On the other hand, the overlapping area between the projected image of the conductor portion 121 and each of the electrical conductors 141 at an opposite direction is decreased so as to result in a decreased amount of capacitance between the operating unit 12 and each of the electrical conductors 141 at the opposite direction. Thus, the controller 13 is configured to determine the moving direction and an amount of the movement of the operating unit 12 with respect to the electrical conductors 141 according to the variation of the capacitance between the operating unit 12 and each of the electrical conductors 141, and to generate the movement signal according to the moving direction and the amount of the movement of the operating unit 12, so as to control the movement of the movable pointer (for example, a cursor or a pick marker on a menu) on the screen of the electronic product.

The following provides three examples of the operation recognizing module implemented by the controller 13.

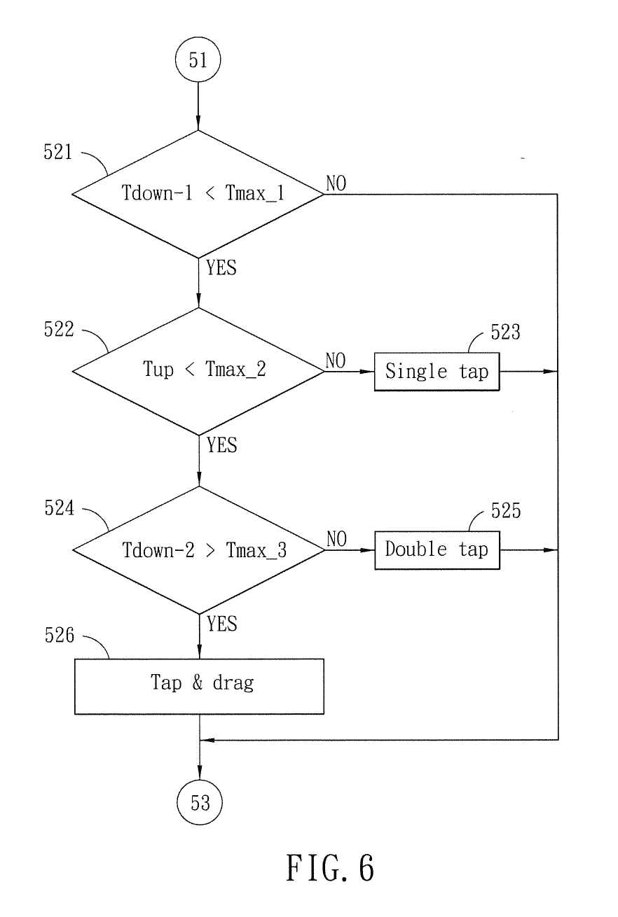

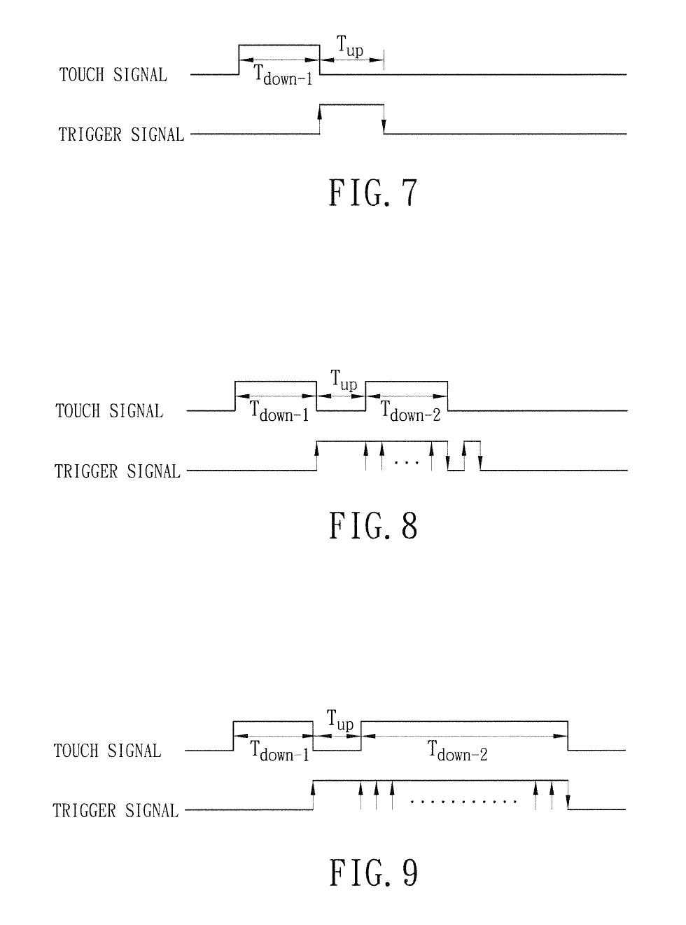

In a first example of the operation recognizing module, referring to FIG. 7, when the capacitance detected by the controller 13 corresponds to the original capacitance, the controller 13 is configured to generate a touch signal transitioning from a logic low level to a logic high level, and when the original capacitance disappears, the touch signal transitions from the logic high level to the logic low level. Referring to FIG. 6, the procedures of the first example of the operation recognizing module (i.e., step 52) are illustrated. In step 521, the controller 13 is configured to determine whether the duration of the occurrence of the original capacitance (T_{down-1}) is shorter than a first predetermined time.

When the determination made instep 521 is negative, the operation recognizing module is terminated and the flow goes to step 53. When it is determined in step 521 that the duration of the occurrence of the original capacitance (T_{down-1}) is shorter than the first predetermined time, the controller 13 is configured, in step 522, to generate a trigger signal transitioning from a logic low level to a logic high level as the touch signal transitions from the logic high level to the logic low level, and to determine whether the original capacitance is detected once again within a second predetermined time which starts at disappearance of the original capacitance. In other words, the controller 13 determines whether the touch signal transitions from the logic low level to the logic low level once again within the second predetermined time which starts when the trigger signal transitions from the logic low level to the logic high level (i.e., whether an interval (Tᵤₚ) between two successive high logic levels of the touch signal is shorter than the second predetermined time).

When the original capacitance is not detected once again within the second predetermined time (Tₘₐₓ_{_{—}}₂), referring to FIG. 7, the trigger signal transitions from the logic high level to the logic low level, and the controller 13 is configured, in step 523, to generate an operation command signal which represents a single tap. Then the operation recognizing module is terminated and the flow goes to step 53. When the original capacitance is detected once again within the second predetermined time, referring to FIG. 8, the trigger signal is kept at the logic high level, and the controller 13 is configured, in step 524, to determine whether the duration of occurrence of the original capacitance that is detected once again (i.e., duration of the touch signal at the high logic level (T_{down-2})) is longer than a third predetermined time.

When the duration of the occurrence of the original capacitance that is detected once again (T_{down-2}) is not longer than the third predetermined time, the trigger signal transitions from the logic high level to the logic low level, and the controller 13 is configured, in step 525, to generate an operation command signal which represents a double tap. When the duration of the occurrence of the original capacitance that is detected once again (T_{down-2}) is longer than the third predetermined time, referring to FIG. 9, the trigger signal is kept at the logic high level, and the controller 13 is configured, in step 526, to continue generating an operation command signal which represents a tap-and-drag operation according to the duration of the occurrence of the original capacitance that is detected once again. The trigger signal transitions from the logic high level to the logic low level at disappearance of the original capacitance. After steps 525 and 526, the operation recognizing module is terminated, and the flow goes to step 53.

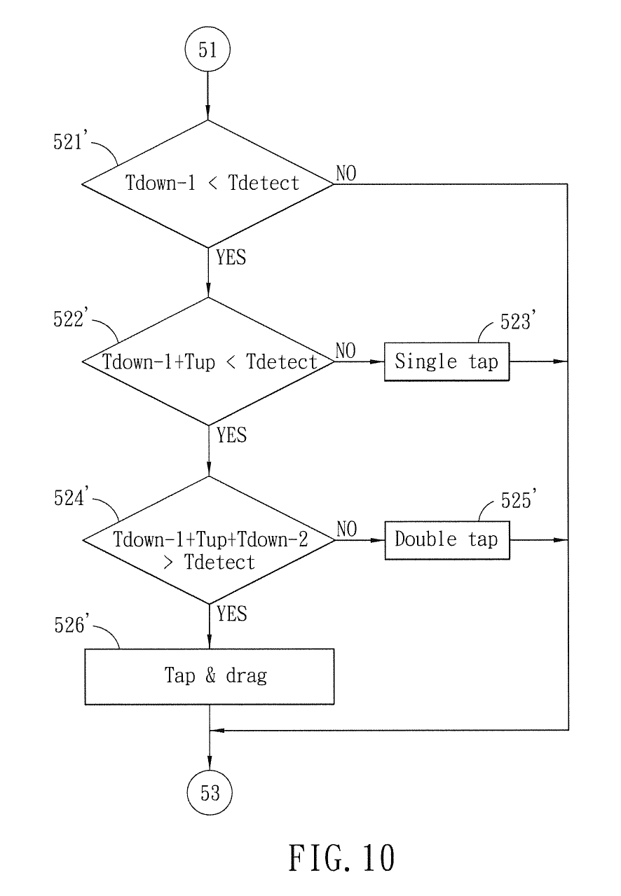

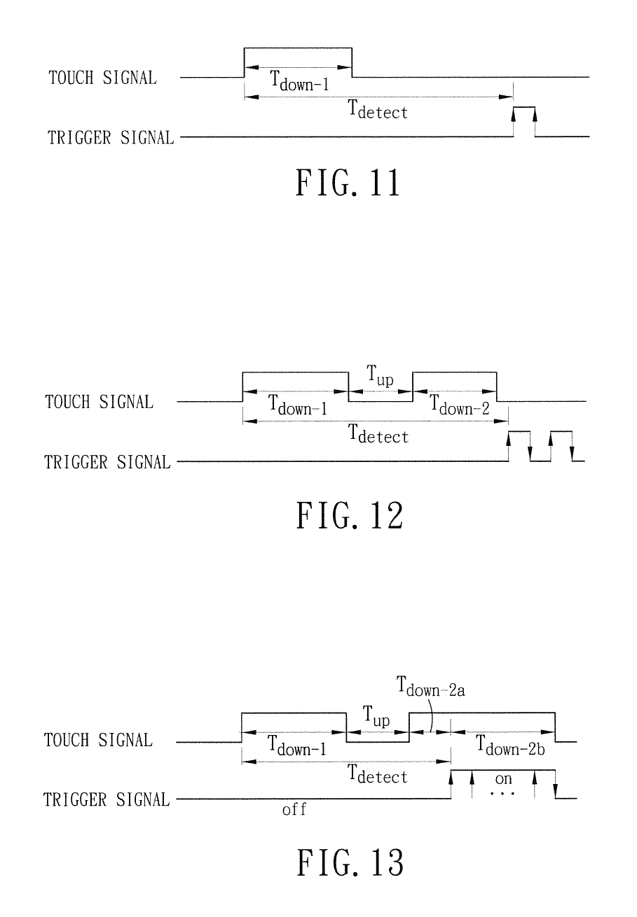

In a second example of the operation recognizing module, referring to FIG. 11, as mentioned above, when the capacitance detected by the controller 13 corresponds to the original capacitance, the controller 13 is configured to generate a touch signal transitioning from a logic low level to a logic high level, and the touch signal is kept at the high logic level until the original capacitance disappears. Referring to FIG. 10, the procedures of the second example of the operation recognizing module (i.e., step 52) are illustrated. In step 521′, the controller 13 is configured to determine whether the duration of the occurrence of the original capacitance (T_{down-1}) is shorter than a fourth predetermined time (T_{detect}).

When the determination made in step 521′ is negative, the operation recognizing module is terminated and the flow goes to step 53. When it is determined in step 521′ that the duration of the occurrence of the original capacitance (T_{down-1}) is shorter than the fourth predetermined time (T_{detect}), the controller 13 is configured, in step 522′, to determine, within a fourth predetermined time (T_{detect}) starting from when the original capacitance is detected, whether the original capacitance disappears and is detected once again. In other words, the controller 13 determines whether the touch signal transitions from the logic high level to the logic low level, is kept at the logic low level for an interval (Tᵤₚ), and transitions from the logic low level to the logic high level.

When the determination made in step 522′ is negative, referring to FIG. 11, the controller 13 is configured, in step 523′, to generate an operation command signal which represents a single tap after the fourth predetermined time (T_{detect}) has elapsed. When the determination made in step 522′ is affirmative, the controller 13 is configured, in step 524′, to determine whether the original capacitance that is detected once again within the fourth predetermined time (T_{detect}) is still detected after the fourth predetermined time (T_{detect}) has elapsed (i.e., whether the touch signal is still at the logic high level after the fourth predetermined time (T_{detect}) has elapsed).

When the original capacitance that is detected once again is not detected after the fourth predetermined time (T_{detect}) has elapsed (i.e., duration of the touch signal at the logic high level (T_{down-2}) has elapsed before the fourth predetermined time (T_{detect}) elapses), referring to FIG. 12, the controller 13 is configured, in step 525′, to generate an operation command signal which represents a double tap after the fourth predetermined time (T_{detect}) has elapsed. When the original capacitance that is detected once again is still detected after the fourth predetermined time (T_{detect}) has elapsed, referring to FIG. 13, the controller 13 is configured, in step 526′, to continue generating an operation command signal which represents a tap-and-drag operation according to the duration of the occurrence of the original capacitance that is detected once again (i.e., according to duration of the touch signal at the high logic level) after the fourth predetermined time (T_{detect}) has elapsed (T_{down-2b}). The trigger signal transitions from the logic high level to the logic low level at disappearance of the original capacitance. After steps 523′, 525′ and 526′, the operation recognizing module is terminated and the flow goes to step 53.

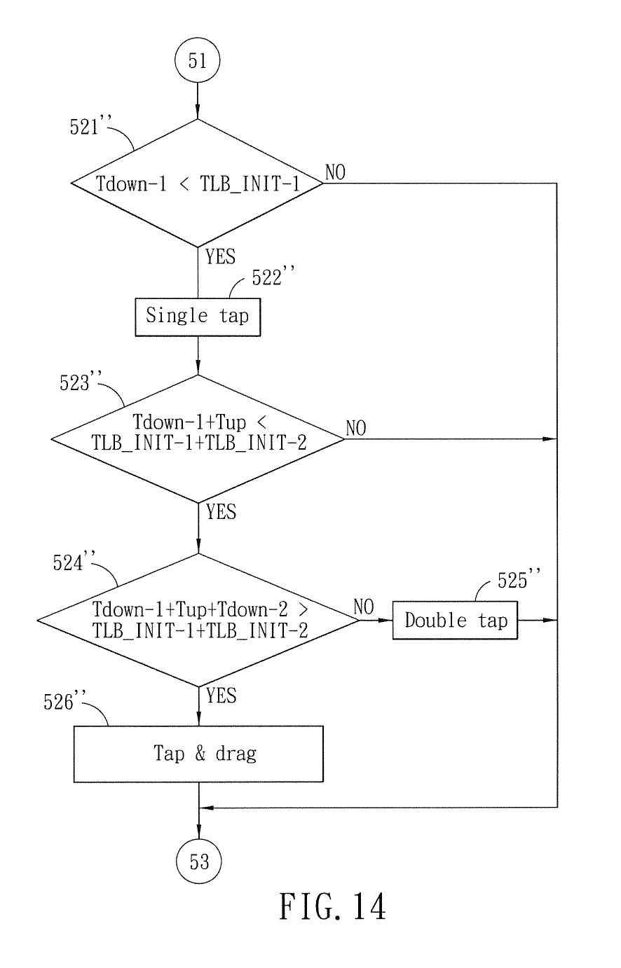

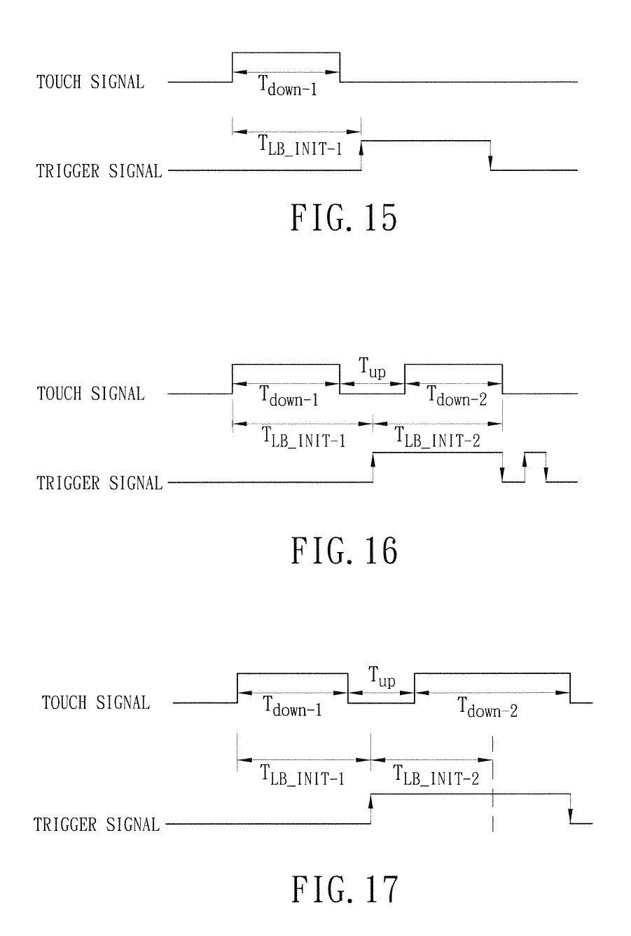

In a third example of the operation recognizing module, referring to FIG. 15, as mentioned above, when the capacitance detected by the controller 13 corresponds to the original capacitance, the controller 13 is configured to generate a touch signal transitioning from a logic low level to a logic high level, and the touch signal is kept at the logic high level and does not transition from the logic high level to the logic low level until the original capacitance disappears. Referring to FIG. 14, the procedures of the third example of the operation recognizing module (i.e., step 52) are illustrated. In step 521″, the controller 13 is configured to determine whether the touch signal transitions from the logic high level to the logic low level within a fifth predetermined time (T_{LB}_{_{—}}_{INIT-1}) which starts when the original capacitance is detected.

When the determination made in step 521″ is negative, the operation recognizing module is terminated and the flow goes to step 53. When it is determined in step 521″ that the touch signal transitions from the logic high level to the logic low level within the fifth predetermined time (T_{LB}_{_{—}}_{INIT-1}), referring to FIG. 15, the controller 13 is configured, in step 522″, to generate a trigger signal transitioning from a logic low level to a logic high level, and to generate an operation command signal which represents a single tap after the fifth predetermined time (T_{LB}_{_{—}}_{INIT-1}) has elapsed. In step 523″, the controller 13 is configured to determine whether the original capacitance is detected once again, i.e., whether the touch signal transitions from the logic low level to the logic high level once again, within a sixth predetermined time (T_{LB}_{_{—}}_{INIT-2}) following the fifth predetermined time (T_{LB}_{_{—}}_{INIT-1}).

When the determination made in step 523″ is negative, the operation recognizing module is finished and the flow goes to step 53. When the original capacitance is detected once again within the sixth predetermined time (T_{LB}_{_{—}}_{INIT-2}), the controller 13 is configured, in step 524″, to further determine whether the original capacitance that is detected once again within the sixth predetermined time (T_{LB}_{_{—}}_{INIT-2}) is still detected after the sixth predetermined time (T_{LB}_{_{—}}_{INIT-2}) has elapsed, i.e., whether the touch signal, which transitions from the logic low level to the logic high level once again within the sixth predetermined time (T_{LB}_{_{—}}_{INIT-2}), is kept at the logic high level for an interval (T_{down-2}) and transitions from the logic high level to the logic low level after the sixth predetermined time (T_{LB}_{_{—}}_{INIT-2}) has elapsed. When the original capacitance that is once again detected within the sixth predetermined time (T_{LB}_{_{—}}_{INIT-2}) is not detected after the sixth predetermined time (T_{LB}_{_{—}}_{INIT-2}) has elapsed, referring to FIG. 16, the controller 13 is configured, in step 525″, to generate an operation command signal which represents a double tap after the sixth predetermined time (T_{LB}_{_{—}}_{INIT-2}) has elapsed. When the original capacitance that is once again detected within the sixth predetermined time (T_{LB}_{_{—}}_{INIT-2}) is still detected after the sixth predetermined time has elapsed, the controller 13 is configured, in step 526″, to continue generating an operation command signal which represents a tap-and-drag operation according to the duration of the occurrence of the original capacitance that is detected once again. The trigger signal transitions from the logic high level to the logic low level at disappearance of the original capacitance. After steps 525″ and 526″, the operation recognizing module is terminated and the flow goes to step 53.

To sum up, the capacitive pointing device 1 of the present invention may generate, according to the variation of the capacitance, the movement signal which represents a movement of the operating unit 12 with respect to the electrical conductors 141 for controlling the moving direction of the movable pointer. Furthermore, the capacitive pointing device 1 may recognize the user operation by the duration of the occurrence of the original capacitance, and may generate the operation command signal corresponding to the user operation recognized therby, so as to achieve a function, similar to a function of a mouse button used to perform a single tap, a double tap, or a tap-and-drag operation.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of recognizing user operation using a capacitive pointing device, the capacitive pointing device including a plurality of electrical conductors and an operating unit that is spaced apart from the electrical conductors and that is configured to result in a capacitance effect with the electrical conductors, an original capacitance between the operating unit and each of the electrical conductors occurring when the operating unit is touched, the method comprising the following steps of:
a) configuring the capacitive pointing device to detect a capacitance between the operating unit and each of the electrical conductors; and
b) when the capacitance detected in step a) corresponds to the original capacitance, configuring the capacitive pointing device to implement an operation recognizing module to recognize the user operation by a duration of occurrence of the original capacitance, and to generate an operation command signal corresponding to the user operation recognized thereby.

2. The method as claimed in claim 1, the operating unit being user-operable to move horizontally with respect to the electrical conductors so as to result in variation of the capacitance between the operating unit and each of the electrical conductors,
wherein the method further comprises, after step b) the steps of:
c) configuring the capacitive pointing device to determine whether an amount of the variation of the capacitance between the operating unit and any one of the electrical conductors is greater than a predetermined threshold, and
d) when the determination made in step c) is affirmative, configuring the capacitive pointing device to implement a direction recognizing module to generate, according to the variation of the capacitance, a movement signal which represents a movement of the operating unit with respect to the electrical conductors.

3. The method as claimed in claim 2, wherein, in the direction recognizing module, the capacitive pointing device is configured to determine a moving direction and an amount of the movement of the operating unit with respect to the electrical conductors according to the variation of the capacitance between the operating unit and each of the electrical conductors, and to generate the movement signal according to the moving direction and the amount of the movement of the operating unit.

4. The method as claimed in claim 1, wherein, in the operation recognizing module, the capacitive pointing device is configured to:
determine whether the duration of the occurrence of the original capacitance is shorter than a first predetermined time;
when it is determined that the duration of the occurrence of the original capacitance is shorter than the first predetermined time, determine whether the original capacitance is detected once again within a second predetermined time which starts at disappearance of the original capacitance;
when the original capacitance is not detected once again within the second predetermined time, generate an operation command signal which represents a single tap;
when the original capacitance is detected once again within the second predetermined time, determine whether the duration of occurrence of the original capacitance that is detected once again is longer than a third predetermined time;
when the duration of the occurrence of the original capacitance that is detected once again is not longer than the third predetermined time, generate an operation command signal which represents a double tap; and
when the duration of the occurrence of the original capacitance that is detected once again is longer than the third predetermined time, continue generating an operation command signal which represents a tap-and-drag operation according to the duration of the occurrence of the original capacitance that is detected once again.

5. The method as claimed in claim 1, wherein in the operation recognizing module, the capacitive pointing device is configured to:
within a fourth predetermined time starting at a moment the original capacitance is detected, determine whether the original capacitance disappears and is detected once again;
when the determination thus made is negative, generate an operation command signal which represents a single tap after the fourth predetermined time has elapsed;
when the determination thus made is affirmative, determine whether the original capacitance that is detected once again within the fourth predetermined time is still detected after the fourth predetermined time has elapsed;
when the original capacitance that is detected once again is not detected after the fourth predetermined time has elapsed, generate an operation command signal which represents a double tap after the fourth predetermined time has elapsed; and
when the original capacitance that is detected once again is still detected after the fourth predetermined time has elapsed, continue generating an operation command signal which represents a tap-and-drag operation according to the duration of the occurrence of the original capacitance that is detected once again.

6. The method as claimed in claim 1, wherein in the operation recognizing module, the capacitive pointing device is configured to:
generate an operation command signal which represents a single tap after a fifth predetermined time, which starts at a moment the original capacitance is detected, has elapsed;
determine whether the original capacitance is detected once again within a sixth predetermined time following the fifth predetermined time;
when the original capacitance is detected once again within the sixth predetermined time, further determine whether the original capacitance that is detected once again within the sixth predetermined time is still detected after the sixth predetermined time has elapsed;
when the original capacitance that is once again detected within the sixth predetermined time is not detected after the sixth predetermined time has elapsed, generate an operation command signal which represents a double tap after the sixth predetermined time has elapsed; and
when the original capacitance that is once again detected within the sixth predetermined time is still detected after the sixth predetermined time has elapsed, continue generating an operation command signal which represents a tap-and-drag operation according to the duration of the occurrence of the original capacitance that is detected once again.

7. The method as claimed in claim 1, wherein, in the operation recognizing module, the capacitive pointing device is configured to generate an operation command signal which represents a single tap when the original capacitance is detected once within a predetermined time.

8. The method as claimed in claim 1, wherein, in the operation recognizing module, the capacitive pointing device is configured to generate an operation command signal which represents a double tap when the original capacitance is detected twice successively within a predetermined time.

9. The method as claimed in claim 1, wherein, in the operation recognizing module, the capacitive pointing device is configured to continue generating an operation command signal which represents a tap-and-drag operation when the original capacitance is detected twice successively within a predetermined time and a later-detected one of the original capacitance is continuously detected.

10. A capacitive pointing device comprising:
at least two electrical conductors which are arranged in an annular shape and are spaced apart from each other;
an operating unit which is spaced apart from said electrical conductors, which is configured to result in a capacitance effect with said electrical conductors, and which includes a touch portion resulting in an original capacitance between the operating unit and each of the electrical conductors when being touched; and
a controller which is electrically coupled to said electrical conductors and said operating unit and which has an operation recognizing module, said controller being configured to
detect a capacitance between said operating unit and each of said electrical conductors,
implement said operation recognizing module to recognize a user operation by a duration of occurrence of the original capacitance when the capacitance detected by said controller corresponds to the original capacitance, and
generate an operation command signal corresponding to the user operation determined thereby.

11. The capacitive pointing device as clamed in claim 10, wherein said controller is configured to determine the occurrence of the original capacitance between said operating unit and each of said electrical conductors when the duration of the occurrence of the original capacitance is longer than a threshold time.

12. The capacitive pointing device as claimed in claim 10, wherein said operating unit is user-operable to move horizontally with respect to said electrical conductors so as to result in variation of the capacitance between said operating unit and each of said electrical conductors, said controller further having a direction recognizing module and being configured to
determine whether an amount of the variation of the capacitance between said operating unit and any one of said electrical conductors is greater than a predetermined threshold, and
implement said direction recognizing module to generate, according to the variation of the capacitance, a movement signal which represents a movement of said operating unit with respect to said electrical conductors when the determination thus made is affirmative.

13. The capacitive pointing device as claimed in claim 12, wherein, in said direction recognizing module, said controller is configured to determine a moving direction and an amount of the movement of said operating unit with respect to said electrical conductors according to the variation of the capacitance between said operating unit and each of said electrical conductors, and to generate the movement signal according to the moving direction and the amount of said movement of the operating unit.

14. The capacitive pointing device as claimed in claim 10, wherein, in said operation recognizing module, said controller is configured to:
determine whether the duration of the occurrence of the original capacitance is shorter than a first predetermined time;
when it is determined that the duration of the occurrence of the original capacitance is shorter than the first predetermined time, determine whether the original capacitance is detected once again within a second predetermined time which starts at disappearance of the original capacitance;
when the original capacitance is not detected once again within the second predetermined time, generate an operation command signal which represents a single tap;
when the original capacitance is detected once again within the second predetermined time, determine whether duration of occurrence of the original capacitance that is detected once again is longer than a third predetermined time;
when the duration of the occurrence of the original capacitance that is detected once again is not longer than the third predetermined time, generate an operation command signal which represents a double tap; and
when the duration of the occurrence of the original capacitance that is detected once again is longer than the third predetermined time, continue generating an operation command signal which represents a tap-and-drag operation according to the duration of the occurrence of the original capacitance that is detected once again.

15. The capacitive pointing device as claimed in claim 10, wherein in said operation recognizing module, said controller is configured to:
within a fourth predetermined time starting at a moment the original capacitance is detected, determine whether the original capacitance disappears and is detected once again;
when the determination thus made is negative, generate an operation command signal which represents a single tap after the fourth predetermined time has elapsed;
when the determination thus made is affirmative, determine whether the original capacitance that is detected once again within the fourth predetermined time is still detected after the fourth predetermined time has elapsed;
when the original capacitance that is detected once again is not detected after the fourth predetermined time has elapsed, generate an operation command signal which represents a double tap after the fourth predetermined time has elapsed; and
when the original capacitance that is detected once again is still detected after the fourth predetermined time has elapsed, continue generating an operation command signal which represents a tap-and-drag operation according to the duration of the occurrence of the original capacitance that is detected once again.

16. The capacitive pointing device as claimed in claim 10, wherein in said operation recognizing module, said controller is configured to:
generate an operation command signal which represents a single tap after a fifth predetermined time, which starts at a moment the original capacitance is detected, has elapsed;
determine whether the original capacitance is detected once again within a sixth predetermined time following the fifth predetermined time;
when the original capacitance is detected once again within the sixth predetermined time, further determine whether the original capacitance that is detected once again within the sixth predetermined time is still detected after the sixth predetermined time has elapsed;
when the original capacitance that is once again detected within the sixth predetermined time is not detected after the sixth predetermined time has elapsed, generate an operation command signal which represents a double tap after the sixth predetermined time has elapsed; and
when the original capacitance that is once again detected within the sixth predetermined time is still detected after the sixth predetermined time has elapsed, continue generating an operation command signal which represents a tap-and-drag operation according to the duration of the occurrence of the original capacitance that is detected once again.

17. The capacitive pointing device as claimed in claim 10, wherein, in said operation recognizing module, said controller is configured to generate an operation command signal which represents a single tap when the original capacitance is detected once within a predetermined time.

18. The capacitive pointing device as claimed in claim 10, wherein, in said operation recognizing module, said controller is configured to generate an operation command signal which represents a double tap when the original capacitance is detected twice successively within a predetermined time.

19. The capacitive pointing device as claimed in claim 10, wherein, in said operation recognizing module, said controller is configured to continue generating an operation command signal which represents a tap-and-drag operation when the original capacitance is detected twice successively within a predetermined time and a later-detected one of the original capacitance is continuously detected.
